(19) United States
(12) Patent Application Publication
(10) Pub. No.: US 2007/0168432 A1
(43) Pub. Date: Jul. 19, 2007

(54) Use of service identifiers to authenticate the originator of an electronic message

(75) Inventors: Paul C. Lustgarten, Westfield, NJ (US); David H. Potter, North Plainfield, NJ (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Cibernet Corporation, Bethesda, MD (US)

(21) Appl. No.: 11/332,155

(22) Filed: Jan. 17, 2006

(51) Int. Cl. G06F 15/16

(52) U.S. Cl. 709/206

(57) ABSTRACT

A system and method for authenticating communication from a message originator to a user is provided. An electronic message is identified as intended for a user. A service identifier associated with the user is retrieved from a database and inserted into a subject field or the body of the electronic message. The service identifier may be lexical, auditory, or visual. The electronic message can be an e-mail message, fax, short message, or multimedia message. The electronic message is then transmitted to a device associated with the user via a network serving the user. The presence of the service identifier in the subject field or message body authenticates that the electronic message originated from the professed message originator.

### FIELD OF THE INVENTION

The present invention is related generally to electronic communication and specifically to authenticating the relationship between the originator and the recipient of an electronic message.

### BACKGROUND OF THE INVENTION

Phishing scams have directly cost the financial industry over one billion dollars to date. The cost to individual consumers is also high. In a phishing attack, individuals are tricked into revealing confidential information by fraudulent e-mail messages. Once the confidential information is obtained, the perpetrator uses the information to facilitate other frauds, such as credit card fraud and/or identity theft.

A phishing e-mail is designed to bait the recipient into taking an action such as opening the e-mail, clicking on an enclosed website link, or responding to the message. The phishing e-mail claims or appears to be from a business, organization, or entity with which the recipient interacts and trusts. The deception is typically achieved through forgery of the sender address and manipulation of the message content. For example, in common phishing scams, the message content has logos and/or trade dress associated with a legitimate entity. In addition, a phishing e-mail includes a subject message that appears to be genuine. For example, subjects such as “Your Account Will Be Suspended,” “IMPORTANT-Account Verification,” “Bank Verification Service,” and “URGENT—Security Notification,” have all been used in recent successful phishing scams.

Phishing scam perpetrators range from amateurs to highly sophisticated criminal organizations. To be profitable, phishing operations rely on e-mailing a significantly large number of users. The value to a perpetrator of a phishing scam is severely diminished if a majority of messages need to be personalized with information not readily available. Furthermore, it is unlikely that a phishing operation will expend the time and resources to focus on an individual customer. Fraud perpetrators, in general, tend to pursue the easiest marks.

One conventional method for combating phishing scams is to include the user's name or display name in the body of the message as a way for the user to validate a message is from the legitimate originator. However, a user's name is a readily available attribute, which can be correlated with an e-mail, short message, or multimedia message. While this technique provides some protection against simple phishing attacks, it is vulnerable to more sophisticated attacks in which the attacker customizes the phishing message with available information specific to the targeted user.

Other techniques for combating phishing scams rely on cryptographic signatures. In these techniques, a message originator attaches a cryptographically-generated signature to a message. The user is then able to validate the attached signature using shared cryptographic information (e.g., public/private key pairs, secret keys, etc.). Because signature generation methods use cryptography, usually public/private key cryptography, they are computationally intense. Therefore, many of these methods are not practical for certain types of mobile wireless devices. In addition, these techniques rely on a widely deployed public-key infrastructure as well as a level of user awareness.

Therefore, what is needed is a system and method for allowing users to quickly authenticate messages from trusted originators.

What is further needed is a system and method for facilitating user authentication of messages from trusted originators that does not require changes to underlying messaging applications, existing message formats, receiving user devices, and/or existing user practices.

What is further needed is systems and methods for facilitating authentication of messages that can be applied to the full range of current and future messaging systems, such as short message service (SMS), multimedia message service (MMS) messages, instant messaging (IM) used on the Internet and, increasingly, mobile telephones, electronically originated facsimiles, and electronic mail (e-mail).

### BRIEF SUMMARY OF THE INVENTION

The present invention is directed to a method for authenticating communication from a message originator to a user. In accordance with the aspects of the invention, a first electronic message is identified as intended for a first user. A first service identifier associated with the first user, or with the first user's relationship with the message originator, is retrieved and inserted into a subject field or the message body of the first electronic message. The electronic message is then transmitted to a first device associated with the first user. The presence of the first service identifier in the subject field or message body authenticates that the first electronic message originated from a legitimate message originator and was in fact intended by that message originator for that first user.

In accordance with further aspects of the invention, a short message is identified as intended for a user. A service identifier associated with the user, or with that user's relationship with the message originator, is retrieved and inserted into a message field of the short message. The short message is then transmitted to a network serving the user for delivery to a device associated with the user.

The present invention is also directed to a system for authenticating communication from a message originator to a user. The system includes means for identifying an electronic message as intended for a user, means for retrieving a service identifier associated with the user or with the user's relationship with that message originator, means for inserting the service identifier into a subject field or message body of the electronic message, and means for transmitting the electronic message to a device associated with the user.

These and other advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an exemplary operating environment for message authentication using user-specified service identifiers, according to an embodiment of the present invention.

FIGS. 2A and 2B depict exemplary electronic messages including a service identifier, according to embodiments of the present invention.

FIG. 3 depicts an exemplary inbox for a user, according to embodiments of the present invention.

FIG. 4 illustrates a block diagram of a data processing unit that can be used to implement the entities shown in FIG. 1, according to an embodiment of the present invention.

FIG. 5 illustrates an exemplary short message service (SMS) operating environment for message authentication using user-specified service identifiers, according to an embodiment of the present invention.

FIG. 6 illustrates an example short message, according to embodiments of the present invention.

FIG. 7 depicts a flowchart of a method for generating a message from a message originator that can be authenticated using user-specified service identifiers, according to an embodiment of the present invention.

FIG. 8 illustrates an exemplary operating environment for facilitating authentication of a postal mail message using service identifiers, according to an embodiment of the present invention

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### 1. Structural Embodiments of the Present Invention

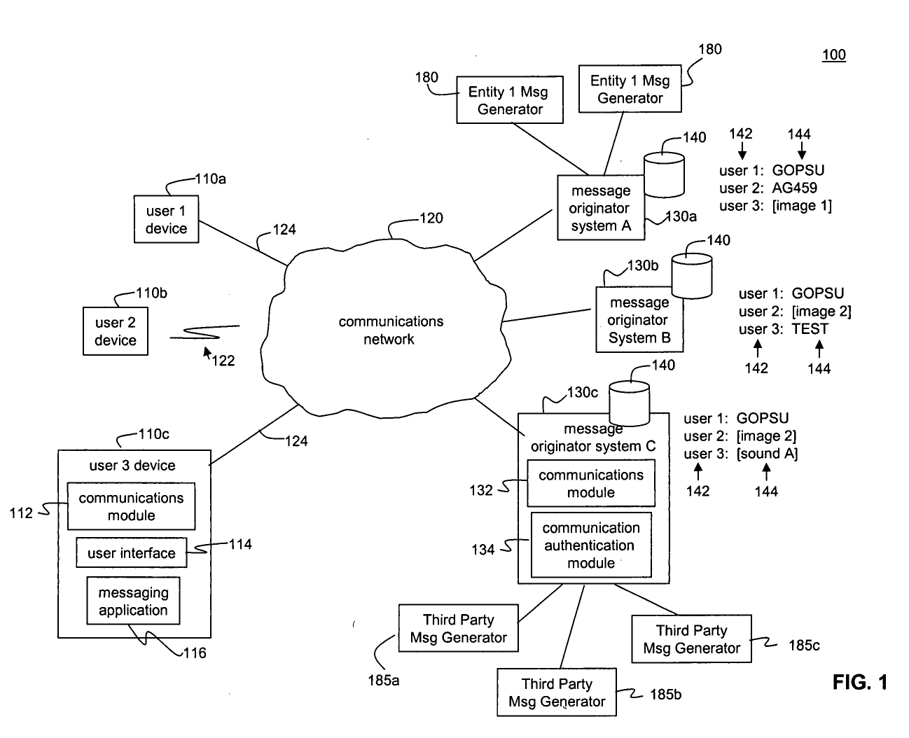

FIG. 1 illustrates an exemplary operating environment 100 for facilitating authentication of a message using service identifiers, according to an embodiment of the present invention. Exemplary operating environment 100 includes one or more user devices 110a-c, a communications network 120, and one or more message originator systems 130a-c.

User devices 100a-c communicate with one or more message originator systems 130a-c via communications network 120. Communications network 120 may be a public data communications network such as the Internet, a private data communications network, the Public Switched Telephone Network (PSTN), a wireless communications network, or any combination thereof. The interface between devices 110a-c and communications network 120 can be a wireless interface 122 or a wired interface 124.

Message originator system 130 includes a communications module 132, a communications authentication module 134, and a database 140. Other embodiments of message originator system 130 may include a subset of these modules and/or may include additional modules. Message originator system 130 may be operated or used by a company, a government agency, an educational institution, or any entity that routinely sends electronically-originated messages to its end-user customers. A message originator system 130 may also be operated or used by an entity that sends electronically-originated messages on behalf of another entity. The entity operating or using a message originator system 130 is referred to herein as a message originator.

The term electronically-originated message includes short messages, multimedia messages, e-mail messages, fax messages, or similar. As would be appreciated by persons of skill in the art, an electronically-originated message can have any format suitable for the network and/or application being utilized. Electronically-originated messages are referred to herein as messages or electronic messages.

In an embodiment, a message originator, such as a corporation, may have multiple message generation systems 180 that route their messages to a single message originator system 130, which then includes the service identifier in the message. In addition or alternatively, multiple third-party generation systems 185a-c may route messages to message originator system 130 for inclusion of the service identifier. The third-party generation system 185a may be operated by an entity such as a corporation, institution, or the like. The third-party generation system 185 may also provide services to multiple entities or to individual users. For example, a user may set up a service identifier for communication with another user. Messages are transmitted from message generation systems 180, third-party generation systems 185a-c, and/or end-user devices via any secure transmission method. The messages may be transmitted via communications network 120, a separate dedicated communication network, or a similar method.

Communications authentication module 134 performs functions associated with the use of service identifiers in communications from a message originator system 130 to a user device 110. Database 140 stores one or more service identifiers 144 for each user identifier (ID) in a set of user IDs 142. FIG. 1 shows exemplary records in database 140 including user ID 142 and service identifier 144 pairs. A service identifier 144 is a secret shared between a message originator 130 and a user. The service identifier 144 is included in messages transmitted by the message originator 130 to the associated user ID 142. The inclusion of the service identifier in the message allows the receiving user to distinguish legitimate messages from phishing or other malicious messages. In an embodiment, service identifier 144 is included in the subject field of the electronic message. Alternatively, the service identifier 144 is included in the content of the message. In a further alternative, service identifier 144 is included in both the subject field and content of the message. Service identifier 144 may be lexical, auditory, visual (static or dynamic), or any combination thereof. A user ID 142 may be an e-mail address, a phone number, a mobile identification number, account handle, or similar address type.

An end user may select a different service identifier 144 for each message originator with which the user interacts. In addition or alternatively, an end user may select the same service identifier 144 for two or more message originators. As depicted in FIG. 1, user 1 opted to use the same service identifier, “GOPSU,” for message originator system A, B, and C. User 2 selected “AG459” for message originator A and an image (image 2) for message originator systems B and C. User 3 selected different service identifiers for each message originator system.

A user may also select multiple service identifiers for communication with a single message originator. The service identifiers may be selected or assigned based on a quality or attribute of a message to be transmitted or based on the mode of communication with the user. For example, a first service identifier can be used for any message that does not require a response from the user (e.g., statement of bank balance or confirmation of a prior interaction). A second service identifier could be used for any message for which a response is requested or required (e.g., approval of a pending transaction). As depicted in FIG. 1, user 3 has selected multiple service identifiers for communications originating from message originator system C 130c.

Communications module 132 enables communication between message originator system 130 and entities external to message originator system, such as user devices 110a-c. Message originator 130 communicates with these entities via communications network 120. It is noted that multiple communications modules 132 may execute in a single message originator system 130. For example, in one embodiment, communications module 132 is a TCP/IP stack. In another embodiment, communications module 132 is a short message service (SMS) or multimedia message service (MMS) communication module. As would be appreciated by persons of skill in the art, other implementations for communications module 132 can be used with the present invention.

User device 110 can be any device capable of receiving electronic communications. User device 110 includes a communication module 112, a user interface 114, and a messaging application 116. Devices 110 may be any type of wired or wireless communication device including, but not limited to, a computer, a lap top, a personal digital assistant (PDA), a wireless telephone, a wired telephone, and televisions.

User interface 114 is preferably a graphical user interface that enables users to interact with the messaging application 116. More generally, user interface 114 controls how functions of the messaging application are presented to users. The user interface 114 also controls how users interact with such functions.

Communications module 112 enables the user device 110 to interact with external entities, such as a message originator 130. In an embodiment, communications module 112 enables TCP/IP traffic. In addition or alternatively, communications module 112 enables wireless SMS and/or MMS traffic. As would be appreciated by persons of skill in the art, communications module 112 is not limited to these examples. More generally, communications module 112 enables communication over any type of communications network 120, such as wireless or wired network and using any communications protocol.

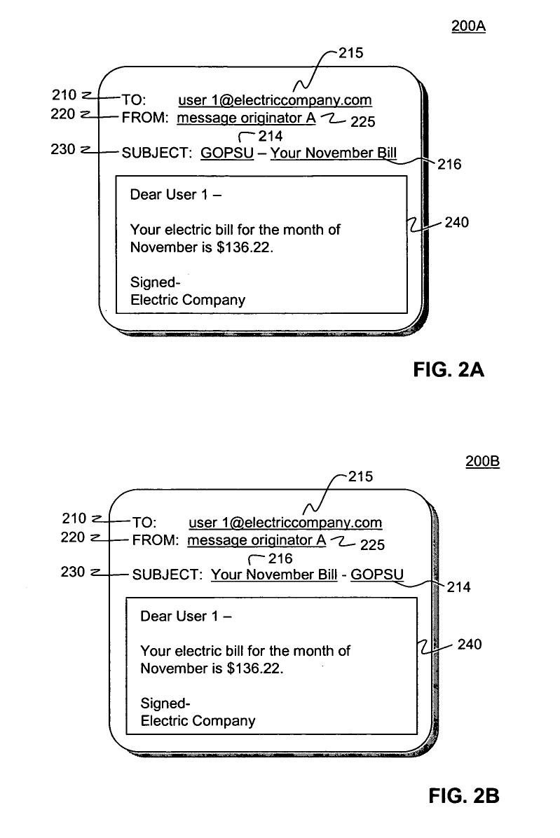

FIGS. 2A and 2B depict exemplary electronic messages 200A and 200B including a service identifier 214, according to embodiments of the present invention. Electronic messages 200A and 200B include a TO field 210, a FROM field 220, a SUBJECT line 230, and content 240. The TO field 210 includes the name and/or electronic messaging address 216 of the intended recipient of the message. The FROM field 220 includes the professed name and/or electronic messaging address 225 of the message originator. In the examples of FIG. 2A and 2B, message originator A is included in the FROM field 225. As described above, forging the sender address is relatively trivial in many messaging applications. Therefore, a user cannot simply rely on recognizing the professed sender as a countermeasure for phishing scams, because the professed sender, as presented in the FROM field, may or may not be the true originator of the message.

The SUBJECT line 230 includes the service identifier 214 and the subject content string 216. FIG. 2A depicts the service identifier 214 as preceding the subject content string 216. FIG. 2B depicts the service identifier 214 as following the subject content string 216. Although these FIGS. 2A and 2B depict the service identifier 214 in particular position of the SUBJECT line 230, a person of skill in the art will recognize that the service identifier 234 can be placed anywhere in the SUBJECT line 230.

Message content 240 includes the body of the electronic message. In an embodiment, the service identifier 214 is included in a prominent position in the message content 240 in addition to or as an alternative to the inclusion in the SUBJECT line.

The user authenticates that the professed message originator 210 is the legitimate originator of the message via the included service identifier 214. For example, the user identifies the service identifier 214 in the message and determines whether the included service identifier 214 is the identifier that the user expects from the legitimate message originator. If the service identifier is the expected value, the user treats the professed message originator as the true message originator. If the service identifier is missing or has an unexpected value, the user knows to treat the message as suspect. As would be appreciated by persons of skill in the art, an application running on the receiving device could also perform the message authentication for the user.

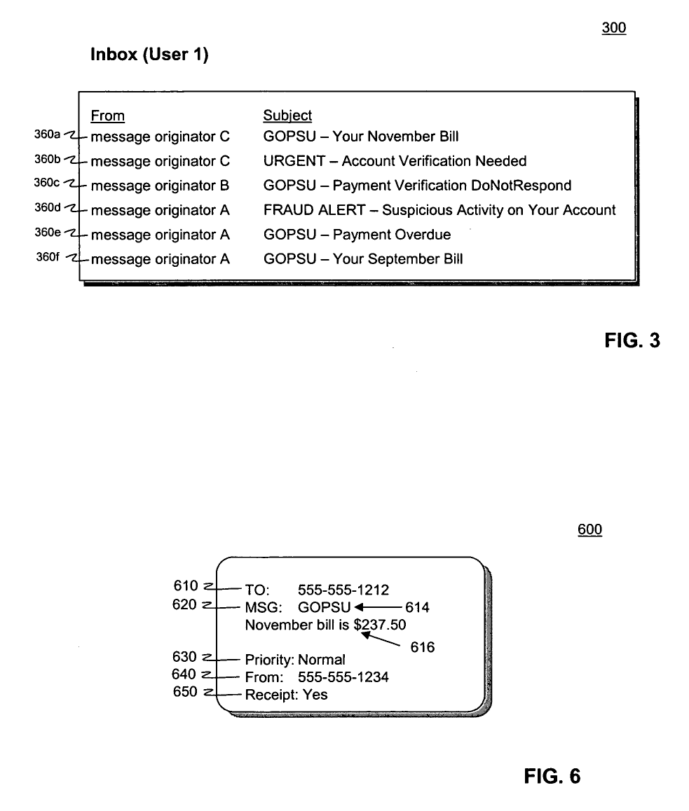

FIG. 3 depicts an exemplary inbox 300 for a user, according to embodiments of the present invention. As can be seen in FIG. 3, electronic messages 360a, 360c, 360e, and 360f include the service identifiers 144 established by user 1. Thus, upon viewing of the message subjects listed in the inbox, an end user can authenticate which messages are from the legitimate message originator. Messages purporting to be from the legitimate message originator and not including the established service identifier can be quickly identified as suspect. For example, electronic messages 360b and 360d appear to be from legitimate message originators C and A, respectively. However, these messages do not include the established service identifier 144. The user is therefore alerted to the strong possibility that these messages are fraudulent and can treat them as such.

### 1.1 Example Implementation Embodiments

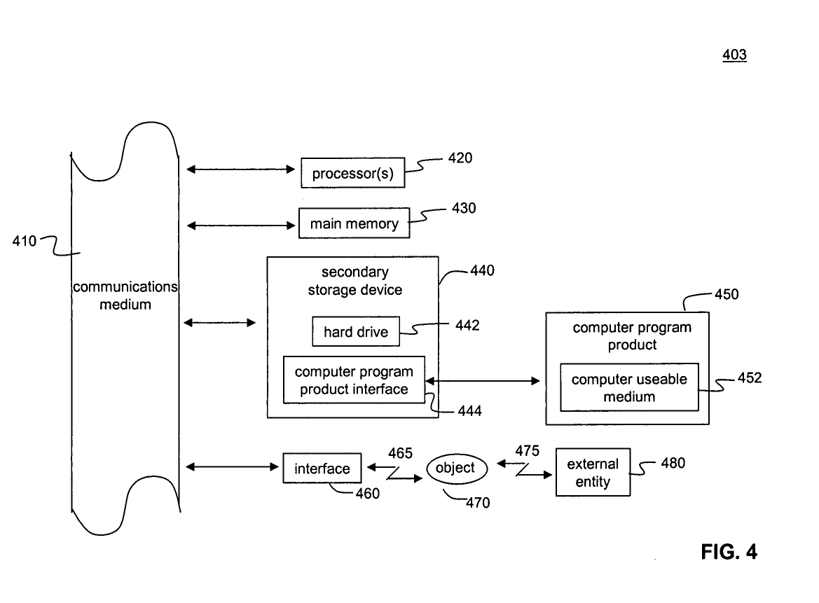

FIG. 4 illustrates a block diagram of a data processing unit 403 that can be used to implement the entities shown in FIG. 1. It is noted that the entities shown in FIG. 4 may be implemented using any number of data processing units 403, and the configuration actually used is implementation specific.

Data processing unit 403 may represent a computer, a hand-held computer, a lap top computer, a personal digital assistant, a mobile phone, and/or any other type of data processing device. The type of data processing device used to implement the entities shown in FIG. 1 is implementation specific.

Data processing unit 403 includes a communications medium 410 (such as a bus, for example) to which other modules are attached.

Data processing unit 403 also includes one or more processors 420 and a main memory 430. Main memory 430 may be RAM, ROM, or any other memory type, or combinations thereof.

Data processing unit 403 may also include secondary storage devices 440 such as, but not limited to, hard drives 442 or computer program product interfaces 444. Computer program product interfaces 444 are devices that access objects (such as information and/or software) stored in computer program products 450. Examples of computer program product interfaces 444 include, but are not limited to, floppy drives, CD drives, DVD drives, ZIP drives, JAZ drives, optical storage devices, etc. Examples of computer program products 450 include, but are not limited to, floppy disks, CDs, DVDs, ZIP and JAZ disks, memory sticks, memory cards, or any other medium on which objects may be stored.

The computer program products 450 include a computer-useable medium 452 on which objects may be stored, such as but not limited to, optical media, magnetic media, etc.

Control logic or software may be stored in main memory 430, second storage device(s) 440, and/or computer program products 450.

More generally, the term “computer program product” refers to any device in which control logic (software) is stored, so in this context a computer program product could be any memory device having control logic stored therein. The invention is directed to computer program products having stored therein software that enables a computer/processor to perform functions of the invention as described herein.

The data processing unit 403 may also include an interface 460 that may receive objects (such as data, applications, software, images, etc.) from external entities 480 via any communications media, including wired and wireless communications media. In such cases, objects 470 are transported between external entities 480 and interface 460 via signals 465, 475. In other words, signals 465, 475 include or represent control logic for enabling a processor or computer to perform the functions of the invention. According to embodiments of the invention, such signals 465, 475 are also considered to be computer program products, and the invention is directed to such computer program products.

### 2.0 Method for Facilitating User Authentication of a Message From a Message Originator Using Service Identifiers

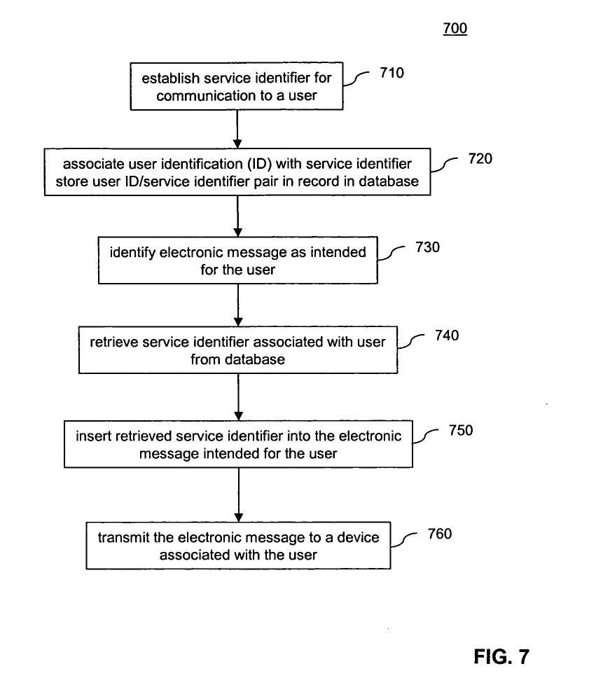

FIG. 7 depicts a flowchart 700 of a method for facilitating authentication of a message from a message originator using service identifiers, according to an embodiment of the present invention. Flowchart 700 will be described with continued reference to the example operating environments depicted in FIG. 1. However, the invention is not limited to that embodiment. Note that some steps shown in flowchart 700 do not necessarily have to occur in the order shown.

In step 710, one or more service identifiers 144 are established for communication from a message originator 130 to a user. The service identifier 144 is established by the user with the entity operating the message originator system 130 or with a third-party message originator. A user may establish a service identifier 144 during a registration with a message originator. For example, a user may establish one or more service identifiers 144 when the user registers for electronic bill payment with an entity. In a further example, a user may establish a service identifier 144 when the user registers with a web site, government entity, educational institution, or similar entity. Registration can occur on-line, via telephone, or other mechanism.

In an embodiment, the user selects a service identifier 144 for all communications originating from the message originator. Alternatively, the message originator system 130 selects the service identifier 144. In either embodiment, the service identifier 144 is specific for an individual user. A user (or message originator system) may also select multiple service identifiers for communications from a message originator system. For example, the service identifiers may be selected or assigned based on a quality or attribute of the message to be transmitted or based on the mode of communication for the message. Alternatively, a user may specify that multiple service identifiers be included in a message from the message originator. For example, the user may select both a visual and an auditory service identifier for messages from a specific message originator.

In step 720, one or more service identifiers 144 are associated with the user ID 142 of the user and stored in a record in database 140.

In step 730, an electronic message is identified as intended for a user. In an embodiment, message originator system 130 generates the electronic message. In addition or alternatively, message originator system 130 receives the electronic message from an external system. For example, a small company may utilize the services of a third-party message originator system 130 for communicating with certain end users using service identifiers. In a further example, a corporation may route all messages requiring service identifiers to one or more message originator systems 130.

In step 740, a service identifier 144 associated with the user is retrieved from database 140. For example, the identified message includes the address or identifier of the recipient (user) of the message. The message originator system 130 uses the address/identifier 142 to retrieve the service identifier 144. If a user has multiple services identifiers for the message originator, the message originator system 130 retrieves a service identifier based on pre-defined rules for the user. For example, the service identifier may be retrieved based on a quality or attribute of the message to be transmitted or based on the mode of communication for the message.

In step 750, the retrieved service identifier 144 is inserted into the electronic message intended for the user. In an embodiment, the service identifier 144 is inserted into the subject field of the message. The service identifier 144 may be placed prior to the subject line content string. Alternatively, the service identifier 144 may be placed following the subject line content string. In an alternate embodiment, the service identifier 144 is inserted in a prominent place in the content of the electronic message. For example, the service identifier 144 may be placed on the first line of the message body. In an embodiment, the service identifier is placed in both the subject line and message body.

In step 760, the electronic message is transmitted to the device (as indicated by the TO address) associated with the user.

Upon receipt of the message, the user authenticates that the professed message originator is the legitimate originator of the message using the service identifier. For example, the user identifies the service identifier in the message and determines whether the included service identifier is the identifier that the user expects from the legitimate message originator for the message type and mode of communication. If the service identifier is the expected value, the user treats the professed message originator as the true message originator. If the service identifier is missing or has an unexpected value, the user knows to treat the message as suspect. As would be appreciated by persons of skill in the art, an application running on the receiving device could also perform the message authentication for the user.

As described above, the method for facilitating authentication of a message from a message originator using service identifiers includes several complementary components. The message originator system 130 prepares the message by retrieving the appropriate service identifier for a message and incorporating that service identifier into the message. The receiving user authenticates the message and its professed originator by identifying the incorporated service identifier and recognizing that the service identifier has the expected value and/or format.

### 3.0 Example Short Message Service (SMS) Implementation

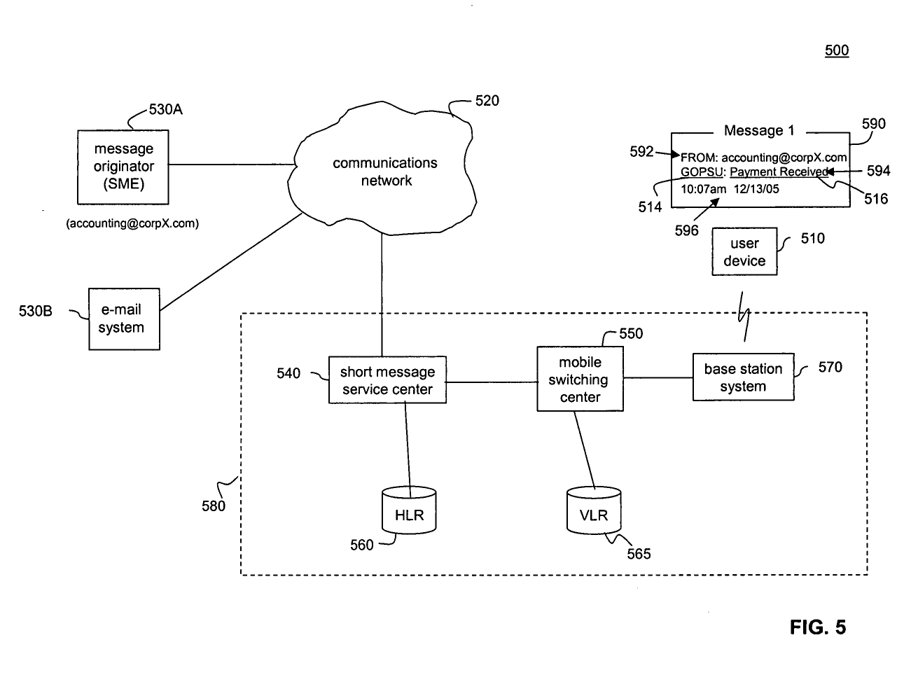

FIG. 5 illustrates an exemplary short message service (SMS) operating environment 500 for facilitating user authentication of a message originator using service identifiers, according to an embodiment of the present invention. Exemplary operating environment 500 includes one or more user devices 510, a communications network 520, a message originator system 530, a short message service center 540, a mobile switching center 550, a home location register (HLR) 560, a visitor location register (VLR) 565, and a base station system 570. Short message service center 540, mobile switching center 550, HLR 560, VLR 565, and base station system 570 are components of an exemplary wireless network 580. Wireless network 580, for example, may be a code division multiple access (CDMA) network, a time division multiple access (TDMA) network, or a global standard for mobiles (GSM) network. As would be appreciated by persons of skill in the art, other network configurations are possible for wireless network 580.

Message originator system 530 is a short messaging entity (SME) 530A (e.g., mobile phone) or an electronic mail system 530B or other entity capable of originating a short message. Short messaging is a wireless service that enables the transmission of short text messages between wireless subscribers and between wireless subscribers and external systems such as electronic mail systems, paging, and voice mail systems. An SME is an entity that is capable of composing a short message.

In general, message originator system 530 generates a short message intended for user device 510. FIG. 6 illustrates an example short message 600, according to embodiments of the present invention. Short message includes a TO field 610, a message field 620, a priority field 630, a FROM field 640 (e.g., call back), and a receipt field 650. Message originator 530 inserts the mobile identification number (MIN) for intended user device 510 into TO field 610. In an embodiment, message originator system 530 places the service identifier 614 at the start of message field 620. In an alternate embodiment, system 530 places the service identifier at the end of the message field 620.

Message originator system 530 submits the short message to the short message service center 540 via a communications network 520. Communications network 520 may be a public data communications network such as the Internet, a private data communications network, the Public Switched Telephone Network (PSTN), a wireless communications network, or any combination thereof.

Short message service center (SMSC) 540 is capable of relaying a short message between the message originator system 530 (SME) and the end user device 510. SMSC 540 may also store-and-forward a short message. Upon receipt of a short message, the SMSC 540 queries the HLR of the intended recipient to obtain routing information for intended recipient 510. The SMSC then transmits the short message to the mobile switching center 550 currently serving the intended recipient 510.

Mobile switching center (MSC) 550 receives the short message from SMSC 540. Upon receipt of the short message, the MSC 550 queries VLR 565 for routing information for the intended recipient. MSC 550 then transmits the short message to user device 510 via base station system 570.

User device 510 can be any device capable of receiving short messages. In an embodiment, user device 510 is a wireless device such as a mobile phone. User device 510 includes a user interface enabling display of received short messages. FIG. 5 depicts an exemplary received short message 590. Exemplary short message 590 includes a FROM field 592, a message field 594, and delivery details 596. FROM field 592 includes the professed address of the entity originating the message. In the example of FIG. 5, the FROM field includes the e-mail address of the message originator 530. FROM field may also or alternatively include a telephone number or other address. Message field 594 includes the service identifier 514 and content string 516. The service identifier 514 is located in a prominent location of message field 594 to allow a user to easily authenticate that the received message is actually from a legitimate message originator.

The above provided a high-level discussion of an exemplary short message system delivery scenario. As would be appreciated by a person of skill in the art, any method for routing and handling short messages can be used with the present invention.

### 4.0 Postal Mail Embodiments

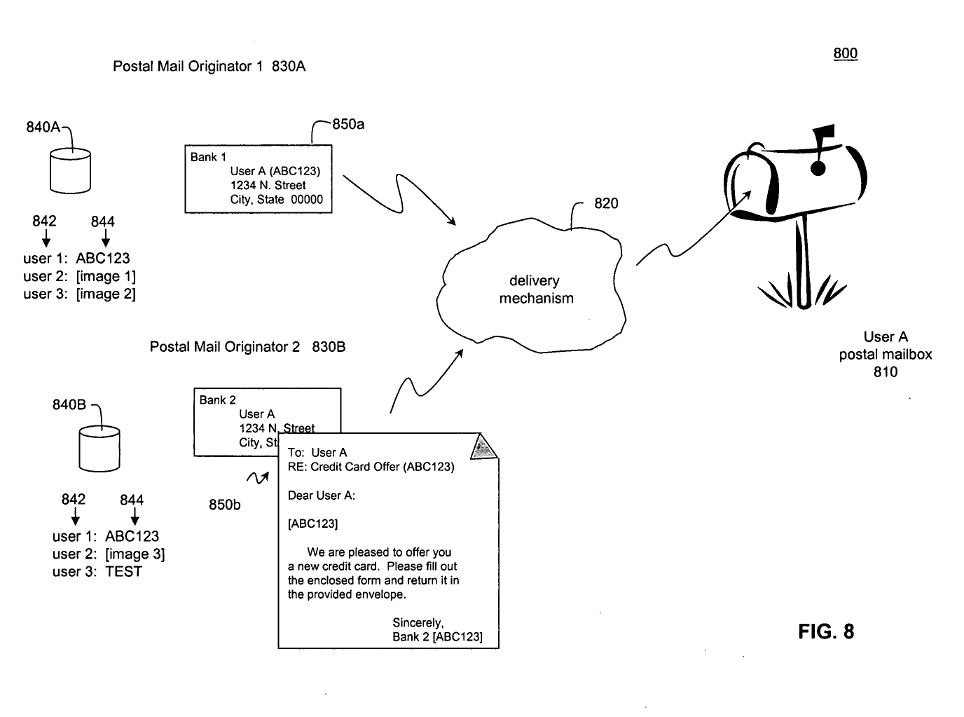

FIG. 8 illustrates an exemplary operating environment 800 for facilitating authentication of a postal mail message using service identifiers, according to an embodiment of the present invention. Phishing scams are not limited to electronic forms of communications. Phishing attacks are also conducted via postal mail. For example, in a postal phishing attack, the mail recipient is duped into filling out a form or returning information or even payment to the scam perpetrator. While not as efficient as electronic phishing attacks, postal phishing attacks allow the scam perpetrator to reach a class of people who may not use electronic communications.

Operating environment 800 includes one or more postal mail originators 830, a postal mail delivery mechanism 820, and one or more end-user postal mailboxes 810. Postal mail delivery mechanism 820 can be any mechanism used to deliver physical letters and/or packages to a user. For example, delivery mechanism 820 may include the United States Postal Service (USPS), Federal Express, UPS, or DHL. The user postal mailbox 810 is a physical location at which the user receives physical letters and/or packages.

Each postal mail originator 830 includes a database 840. Database 840 stores one or more service identifiers for each user with whom the postal mail originator sends correspondence. For example, a user may be identified in database 840 by his or her postal address. FIG. 8 shows exemplary records in a database 840 including user 842 and service identifier pairs 844. As described above, a service identifier is a secret shared between the postal mail originator and the user. In the postal mail embodiment, a service identifier may be lexical, visual, or a combination thereof.

The service identifier 844 is included in physical postal mail delivered to the user. In an embodiment, the service identifier 844 is included in the recipient address on the front of the mail envelope. Letter 850a of FIG. 8 illustrates the inclusion of the service identifier on the mail envelope. Alternatively, the service identifier may be included in one or more of the RE: line, correspondence body, and/or signature block of the letter. Letter 850b of FIG. 8 illustrates the inclusion of the service identifier in multiple locations of a letter. In a further embodiment, the service identifier is included on the envelope and in one or more locations within the enclosed letter.

The inclusion of the service identifier in the postal mail message allows the recipient to quickly distinguish legitimate mail from phishing mail. For example, the user identifies the service identifier on the envelope and/or content of the enclosed correspondence and determines whether the included service identifier is the identifier that the user expects. If the service identifier is expected, the user treats the mail as from a legitimate message originator. If the service identifier is missing or has an unexpected value, the user can treat the mail as suspect.

### 5.0 Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for facilitating authentication of a communication from a message originator to a user, the method comprising:
(a) identifying a first electronic message as intended for a first user;
(b) retrieving a first service identifier associated with the first user;
(c) inserting the first service identifier into a subject field of the first electronic message; and
(d) transmitting the electronic message to a first device associated with the first user,
whereby the presence of the first service identifier in the subject field authenticates that the first electronic message originated from a legitimate message originator.

2. The method of claim 1, wherein step (c) comprises:
inserting a lexical service identifier into the subject field of the first electronic message.

3. The method of claim 1, wherein step (c) comprises:
inserting an audio service identifier into the subject field of the first electronic message.

4. The method of claim 1, wherein step (c) comprises:
inserting a visual service identifier into the subject field of the first electronic message.

5. The method of claim 1, further comprising:
prior to step (a), establishing a first service identifier for communications from the first message originator to the first user.

6. The method of claim 1, wherein step (c) comprises:
inserting the first service identifier in the subject field of the first electronic message prior to a subject line content string.

7. The method of claim 1, wherein step (c) comprises:
inserting the first service identifier in the subject field of the first electronic message following a subject line content string.

8. The method of claim 1, further comprising:
(e) identifying a second electronic message as intended for a second user;
(f) retrieving a second service identifier associated with the second user;
(g) inserting the second service identifier into a subject field of the second electronic message for the second user; and
(h) transmitting the electronic message to a second device associated with the second user,
whereby the second service identifier authenticates that the second electronic message originated from the legitimate message originator.

9. The method of claim 1, wherein the first electronic message is a short message service (SMS) message.

10. The method of claim 8, wherein the second electronic message is a short message service (SMS) message.

11. The method of claim 1, wherein the first electronic message is a multimedia message service message.

12. The method of claim 1, wherein the first electronic message is a facsimile message.

13. The method of claim 1, wherein the first electronic message is an e-mail message.

14. The method of claim 1, wherein the first electronic message is an instant message.

15. The method of claim 1, wherein step (b) further comprises:
(b) retrieving a first service identifier associated with the first user based on an attribute of the first electronic message.

16. The method of claim 1, further comprising:
prior to step (a), establishing a plurality of service identifiers for communications from the first message originator to the first user.

17. A method for authenticating a short message from a message originator to a user, the method comprising:
(a) identifying a short message as intended for a user;
(b) retrieving a service identifier associated with the user;
(c) inserting the service identifier into a message field of the short message; and
(d) transmitting the short message to a network serving the user for delivery to a device associated with the user,
wherein the presence of the first service identifier in the message field authenticates that the short message originated from the message originator.

18. The method of claim 17, wherein step (c) comprises:
inserting a lexical service identifier into the message field of the short message.

19. The method of claim 17, wherein step (c) comprises:
inserting an audio service identifier into the message field of the short message.

20. The method of claim 17, wherein step (c) comprises:
inserting a visual service identifier into the message field of the short message.

21. The method of claim 17, further comprising:
prior to step (a), establishing a service identifier for short message communications from the message originator to the first user.

22. The method of claim 17, wherein step (c) comprises:
inserting the first service identifier in the message field prior to a message content string.

23. The method of claim 17, wherein step (c) comprises:
inserting the first service identifier in the message field following a message content string.

24. A system for authenticating communication from a message originator to a user, comprising:
means for identifying an electronic message as intended for a user;
means for retrieving a service identifier associated with the user;
means for inserting the service identifier into a subject field of the electronic message; and
means for transmitting the electronic message to a device associated with the user,
whereby the presence of the service identifier in the subject field authenticates that the electronic message originated from a legitimate message originator.

25. The system of claim 24, wherein the service identifier is a lexical service identifier.

26. The system of claim 24, wherein the service identifier is an audio service identifier.

27. The system of claim 24, wherein the service identifier is a visual service identifier.

28. The system of claim 24, wherein the electronic message is a short message.

29. The system of claim 24, further comprising:
means for establishing a service identifier for communication from the message originator to the user.

30. The system of claim 29, wherein the user establishes a different service identifier for each of a plurality of message originators.

31. The system of claim 29, wherein the user establishes the same service identifier for each of a plurality of message originators.

32. The system of claim 24, further comprising:
means for establishing a plurality of service identifiers for communication from the message originator to the user.

33. The system of claim 32, wherein the means for establishing a plurality of service identifiers includes:
means for establishing criteria defining which service identifier in the plurality of service identifiers is included in a message,

34. The system of claim 24, further comprising:
means for receiving an electronic message requiring inclusion of a service identifier.

35. The system of claim 34, wherein the means for receiving an electronic message comprises:
means for receiving an electronic message requiring inclusion of a service identifier from a plurality of external entities.
